(19) United States
(12) Patent Application Publication
(10) Pub. No.: US 2005/0025127 A1
(43) Pub. Date: Feb. 3, 2005

(54) Method and apparatus for communication web services

(76) Inventor: Carl R. Strathmeyer, Reading, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/632,286

(22) Filed: Jul. 31, 2003

(51) Int. Cl. H04L 12/66

(52) U.S. Cl. 370/352

(57) ABSTRACT

Techniques for a communications web services system are described.

### BACKGROUND

Computer-Telephony Integration (CTI) may refer to systems that enable a computer to operate as a telephone call center, accepting incoming calls and routing them to the appropriate device or person. CTI systems may handle all sorts of incoming and outgoing communications, including telephone calls, facsimile, and Internet messages. CTI systems may also synchronize telephony operations with application systems. For example, when a telephone call arrives at a workstation for a customer service representative, a file related to the customer may be displayed on the computer. Conventional CIT systems, however, may not be suitable for use with Web-based application systems. Consequently, there may be need for improvements in such techniques in a device or network.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a Communications Web Services (CWS) system in accordance with one embodiment;

FIG. 2 illustrates a CWS web server in accordance with one embodiment; and

FIG. 3 is a block flow diagram of the programming logic performed by a CWS web server in accordance with one embodiment.

### DETAILED DESCRIPTION

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

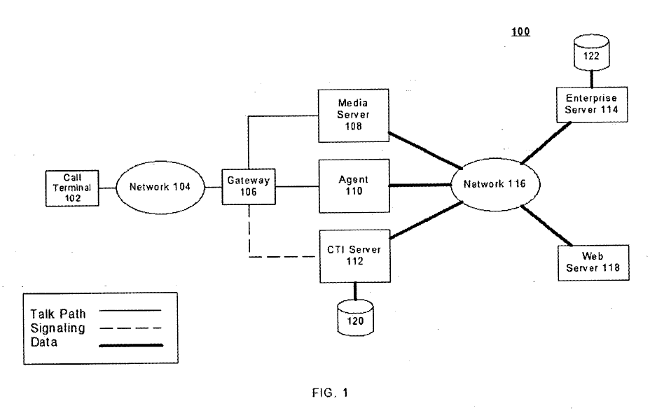

Referring now in detail to the drawings wherein like parts are designated by like reference numerals throughout, there is illustrated in FIG. 1 a system suitable for practicing one embodiment. FIG. 1 is a block diagram of a system 100 comprising a number of network nodes connected by one or more communications mediums. A network node (“node”) in this context may include any device capable of communicating information, such as a computer, server, switch, router, bridge, gateway, personal digital assistant, mobile device, call terminal and so forth. A communications medium in this context may include any medium capable of carrying information signals, such as twisted-pair wire, co-axial cable, fiber optics, radio frequencies, and so forth. The terms “connection” or “interconnection,” and variations thereof, in this context may refer to physical connections and/or logical connections.

In one embodiment, system 100 may comprise a Communications Web Services (CWS) system. The term “CWS” as used herein may refer to the techniques used to integrate and manage the operations of a CTI system and a web application system, in accordance with one or more embodiments.

More particularly, a CWS system may extend the functionality offered by conventional CTI systems to encompass web application systems. In at least one embodiment, a CTI system may be directed to integrating computer and telephony systems into a single system. CTI systems may provide enhanced functionality relative to conventional telephone systems by combining traditional telephone functions with application programs executed by a computer. For example, when a telephone call arrives at a desk for a customer service representative, a file related to the customer may be displayed on the computer. In another example, a caller may connect to an Interactive Voice Response (IVR) system to automatically retrieve information, such as an account balance from a bank or credit card company. Conventional approaches to the design and implementation of CTI applications, however, may not work well in a web-style application environment. This may be because web application environments handle transaction and session context differently from traditional designs. Further, a web application environment partitions functions differently among processing systems. A CWS system extends the functionality for a CTI system by coordinating web application services with traditional telephony and computer systems. This coordination may be commercially important in many fields, including the implementation of Web-based customer service systems.

Furthermore, conventional techniques for telephony/data synchronization generally rely on application-specific software residing on agent desktops and in media servers such as IVR systems. The embodiments do not necessarily require any such resident software, thereby reducing the installation and management of these applications, and increasing support for widely-distributed systems and remote users. For example, one embodiment is able to synchronize telephony and application operations using a standard web browser on the agent desktop, thus making it unnecessary to install any application-specific software on such desktops. Instead, telephone-related application logic is concentrated on the CWS web server where it can be more easily installed and managed.

In one embodiment, CWS system 100 may communicate various types of information between the various network nodes. For example, one type of information may comprise “media information.” Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Another type of information may comprise “control information.” Control information may refer to any data representing commands, instructions or control words meant for an automated system For example, control information may be used to route media information through a network, or instruct a network node to process the media information in a predetermined manner.

In one embodiment, system 100 may comprise a call terminal 102, a telephony network 104, a media server 108, an agent workstation 110, a CTI server 112, a network 116, an enterprise server 114, and a web server 118. CTI server 112 may further comprise a call database 120. Enterprise server 114 may further comprise a caller database 122. The network nodes of system 100 may all be connected with one or more physical communications mediums. The network nodes may communicate media and control information with each other over the physical communications mediums using one or more logical communication channels or paths.

In one embodiment, CWS system 100 may include call terminal 102. Call terminal 102 may comprise any device capable of communicating audio information, such as a telephone, a packet telephone, a mobile or cellular telephone, a processing system equipped with a modem or Network Interface Card (NIC), and so forth. In one embodiment, the call terminals may have a microphone to receive analog voice signals from a user, and a speaker to reproduce analog voice signals received from another call terminal.

In one embodiment, CWS system 100 may include a media server 108. Media server 108 may comprise a device to act as an automated call endpoint, either accepting or terminating inbound calls or launching outbound calls. In one embodiment, media server 108 may operate as an IVR system. An IVR system may listen and speak on these calls as directed by scripts provided by web server 118. The scripts may be requested from web server 118 as needed to process a particular call during a call session. The term “call session” may refer to a period of time a telephone call is active.

In one embodiment, the term “scripts” may refer to a batch file or macro file containing command instructions for execution by a processor. The scripts may be composed using any industry-standard scripting languages, such as Hypertext Markup Language (HTML), Extensible Markup Language (XML), Speech Application Language Tags (SALT), Wireless Markup Language (WML), Voice Extensible Markup Language (VoiceXML), and so forth. The embodiments are not limited in this context.

In one embodiment, CWS system 100 may include agent workstation 110. Agent workstation 110 may comprise a workstation for a human user or agent of CWS system 100. The workstation may refer to both the telephone equipment and the computer equipment for the agent. The operations between the telephone equipment and the computer equipment do not necessarily need to be interconnected at agent workstation 110, but the operations should be synchronized. For example, when a call arrives at the telephone for agent workstation 110, the computer for agent workstation 110 may use an application system to retrieve and display certain data related to the call session or the caller.

In one embodiment, CWS system 100 may comprise CTI server 112. CTI server 112 may be a CTI server to maintain call information. The term “call information” may refer to any data associated with a call session. Examples of call information may comprise telephony event information from the telephony network as well as application data from the application system. Examples of telephony event information may comprise a dialed telephone number, a telephone line used to complete the call, or any other information typically associated with a telephone call. Examples of application data from the application system may comprise, for example, an account number, Personal Identification Number (PIN), application commands, or any other information provided by a caller or relevant to a call session.

In one embodiment, CTI server 112 may use call information to monitor the progress and status of each call. Further, CTI server 112 may associate the appropriate application data with each call, and may also send call operation commands to telephony network 104 when requested by the application system. CTI server 112 may communicate with other network nodes using any convenient data networking or data base access protocols. For example, in one embodiment CTI server 112 may utilize Web Services XML/Simple Object Access Protocol (SOAP). The embodiments are not limited in this context.

In one embodiment, CWS system 100 may include an enterprise server 114. The term “enterprise” may refer to a business organization that utilizes computers and computer networks. Enterprise server 114 may be any enterprise server connected to system 100 that may store caller information. The term “caller information” may refer to any data associated with a caller. Examples of caller information may comprise scripts, handling instructions, an account number, account profile, account information, financial information, medical information, legal information, or any other information typically associated with a caller. The embodiments are not limited in this context. The caller information may be stored in caller database 122 of enterprise server 114, for example.

In one embodiment, web server 118 may also store caller information. For example, caller information may comprise IVR scripts or web page templates associated with a particular caller. This may be useful in providing varying levels of customer service. In this case, web server 118 may retrieve the needed caller information from its internal caller database, thereby potentially improving processing throughput and reducing delay. In another example, web server 118 may have a cache storing caller information from a previous or current call session. Web server 118 may check the cache for caller information using conventional caching techniques prior to attempting to, retrieve the caller information from another server. The type and amount of caller information stored by web server 118 may vary according to a particular implementation, and the embodiments are not limited in this context.

In one embodiment, CWS system 100 may comprise web server 118. Web server 118 may be a web server having web application software, such as a web page generator. The web page generator may create dynamic web pages upon request by a client. The client may be, for example, media server 108 or agent workstation 10. A dynamic web page may be differentiated from a static web page in that the content of the web page is not created until a request is received. When a web browser requests a dynamic page from web server 118, the web page generator may consult a template that specifies how to construct the requested page. The template may include or refer to variable information and algorithms which, when executed, provide content that enables the web page generator to fill in the template to make a complete web page.

The term “web page” as used herein may refer to a document created in accordance with one or more scripting languages. Examples of a web page may include a script for use by an IVR system, a document for display on a web browser, a document for audio reproduction by a voice portal, a document for display by a wireless device such as a mobile telephone or Personal Digital Assistant (PDA), and so forth. The embodiments are not limited in this context.

In one embodiment, web server 118 may include a CWS interface to other network nodes in CWS system 100 to retrieve information for the web applications(s) running on web server 118. For example, the CWS interface may include a call information interface. The term “call information interface” as used herein may refer to any interface to retrieve call information. The call information interface may retrieve call information from a call database, such as call database 120 of CTI server 112. In another example, the CWS interface may include a caller information interface. The term “caller information interface” as used herein may refer to any interface to retrieve caller information. The caller information interface may retrieve caller information from a caller database, such as a caller database 122 of enterprise server 114, or a caller database that is internal to web server 118. It may be appreciated that the CWS interface may include other interfaces for other types of information, or to different network nodes, as desired for a given implementation. The embodiments are not limited in this context.

In one embodiment, web server 118 may select a web page template based on the type of request or the client. Web server 118 may then use the call information interface and/or caller information interface to retrieve the appropriate content to fill in the web page template. The dynamic web page may use the call information and/or caller information to fill in the web page template. This allows the web page generator to create a finished web page that reflects data relevant to a caller. Web server 118 may then send the completed web page to the requesting client, such as media server 108 or agent workstation 110, for example.

In one embodiment, CWS system 100 may include a telephony network 104. Telephony network 104 may establish the calls to be synchronized with the application system. In one embodiment, telephony network 104 may comprise a Private Branch Exchange (PBX), a Centrex System, an Automatic Call Distributor (ACD), or any combination thereof. A PBX may be a private telephone network used within, for example, an enterprise. A Centrex is similar to a PBX as implemented by a Local Exchange Carrier (LEC). An ACD may be a telephone facility that handles incoming calls and manages them based on a database of handling instructions. The embodiments are not limited in this context.

In one embodiment, telephony network 104 may be implemented as a VOP network. A VOP network may be directed to communicating voice information over a packet network in accordance with one or more VOP protocols, such as the International Telecommunication Union (ITU) H.323 protocol, Internet Engineering Task Force (IETF) Session Initiation Protocol (SIP), ITU Megaco protocol, and so forth. A VOP network may include such components as a media gateway, media gateway controller, conference servers, application servers, and so forth. A VOP network may also include the appropriate interfaces to a circuit-switched network, such as the Public Switched Telephone Network (PSTN).

In one embodiment, telephony network 104 should include a CTI link to CTI server 112 as indicated in FIG. 1. Telephony network 104 may send control information through the CTI link to CTI server 112 to report the status of calls, and also to accept requests from other nodes to setup, tear down or rearrange calls.

In one embodiment, a portion of telephony network 104 may also comprise the PSTN. The PSTN is a public network, and typically comprises one or LEC and Inter Exchange Carriers (IXC).

In one embodiment, CWS system 100 may include a network 116. Network 116 may comprise a data network, such as packet network. A packet network may communicate information over a network in the form of packets. A packet in this context may refer to a set of information of a limited length, with the length typically represented in terms of bits or bytes. An example of a packet length might be 1100 bytes. The particular length of a packet may vary according to a desired implementation.

In one embodiment, network nodes of CWS system 100 may communicate information between each other via network 116 in accordance with one or more communication protocols. A communication protocol may comprise a set of instructions by which information is communicated over the communications medium. In one embodiment, for example, network 116 may operate in accordance with one or more Internet protocols such as the Transmission Control Protocol/Internet Protocol (TCP/IP), SOAP, the Hypertext Transport Protocol (HTTP), and so forth. The embodiments are not limited in this context.

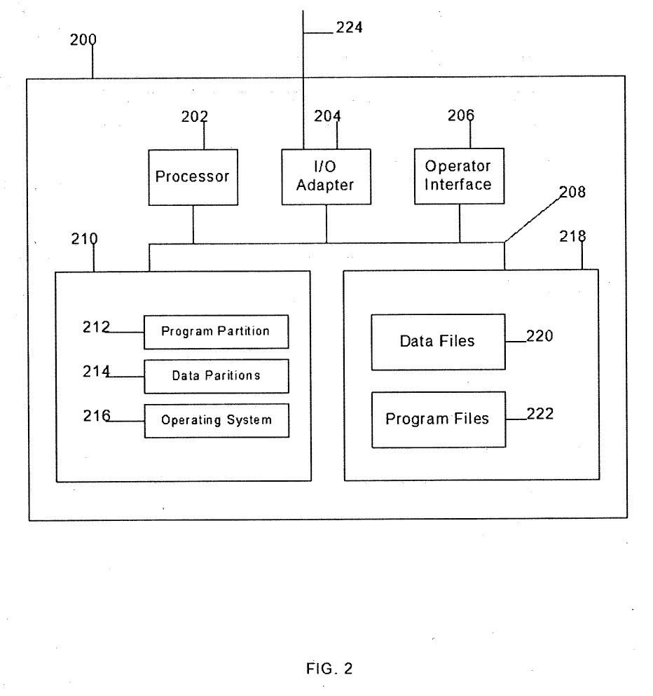

FIG. 2 illustrates a CWS web server in accordance with one embodiment. FIG. 2 illustrates a CWS web server 200. CWS web server 200 may be representative of, for example, web server 118. CWS web server 200 may implement functionality for the various embodiments as software executed by a processor, hardware circuits or structures, or a combination of both. The embodiments are not limited in this context.

As shown in FIG. 2, CWS web server 200 includes a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. Processor 202 executes the program instructions, and processes the data, stored in memory 210. Disk storage 218 stores data to be transferred to and from memory 210. I/O adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements. I/O adapter 204 represents one or more I/O adapters or NIC that can connect to a network or system, such as the networks or systems described with reference to FIG. 1. Therefore, connection 224 represents a network or a direct connection to other equipment.

Processor 202 can be any type of processor capable of providing the speed and functionality required by the embodiments. For example, processor 202 may be any general purpose processor, such as a processor made by Intel Corporation, for example. Processor 202 may also comprise a digital signal processor (DSP) and accompanying architecture, or other dedicated processor such as a network processor, embedded processor, micro-controller, controller and so forth.

In one embodiment, memory 210 and disk storage 218 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM) and any other media that may store digital information. In one embodiment, the instructions are stored on the medium in a compressed and/or encrypted format. As-used herein, the phrase “adapted to be executed by a processor” is meant to encompass instructions stored in a compressed and/or encrypted format, as well as instructions that have to be compiled or installed by an installer before being executed by the processor. Further, CWS web server 200 may contain various combinations of machine-readable storage devices through various I/O controllers, which are accessible by processor 202 and which are capable of storing a combination of computer program instructions and data.

Memory 210 is accessible by processor 202 over bus 208 and includes an operating system 216, a program partition 212 and a data partition 214. In one embodiment, operating system 216 may comprise an operating system sold by Microsoft Corporation, such as Microsoft Windows® 95, 98, 2000, and XP, although the embodiments are not limited in this context. Program partition 212 stores and allows execution by processor 202 of program instructions that implement the functions for CWS web server 200. Data partition 214 is accessible by processor 202 and stores data used during the execution of program instructions.

Program partition 212 may contain one or more web application modules consisting of program instructions that are executed by CWS web server 200. In one embodiment, for example, program partition 212 may store program instructions for a call information interface module. The call information interface module may provide call information to the application(s) running on web server 118. The call information may be stored in a call database, such as call database 120. In one embodiment, program partition 212 may store program instructions for a caller information interface module. The caller information interface module may provide caller information for the application(s) running on web server 118. The caller information may be stored in a caller database, such as caller database 122. In one embodiment, program partition 212 may store program instructions for a web page generator module. The web page generator module may generate dynamic web pages using the call information and caller information. It may be appreciated that the embodiments are not necessarily limited to these particular sets of instructions.

I/O adapter 204 may comprise a network adapter or NIC configured to operate with any suitable technique for controlling communication signals between computer or network devices using a desired set of communications protocols, services and operating procedures, for example. I/O adapter 204 also includes appropriate connectors for connecting I/O adapter 204 with a suitable communications medium.

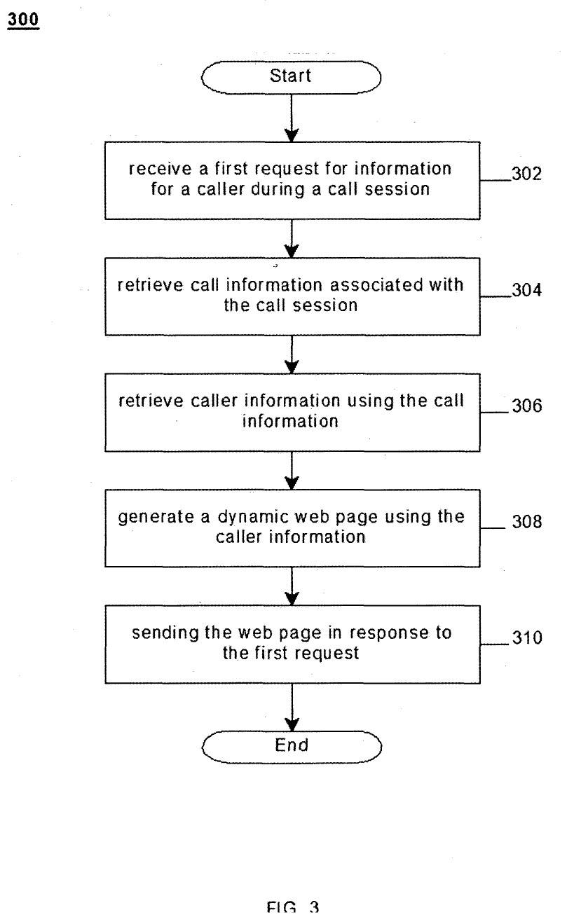

The operations of systems 100 and 200 may be further described with reference to FIG. 3 and accompanying examples. Although FIG. 3 as presented herein may include a particular programming logic, it can be appreciated that the programming logic merely provides an example of how the general functionality described herein can be implemented. Further, each operation within a given programming logic does not necessarily have to be executed in the order presented unless otherwise indicated.

FIG. 3 illustrates a block flow diagram for the programming logic performed by various application modules for a CWS web server. In one embodiment, these modules may refer to the software and/or hardware used to implement the functionality for one or more embodiments as described herein. In this embodiment, these modules may be implemented as part of CWS web server 200. It can be appreciated that this functionality, however, may be implemented by any device, or combination of devices, located anywhere in CWS system 100 and still fall within the scope of the embodiments.

FIG. 3 illustrates a programming logic 300 to manage information for a CWS system. A first request for information for a caller during a call session may be received at block 302. The term “first request” as used herein may refer to any request between a client and web server 118 during any given call session, and is not necessarily limited to the actual first request received by web server 118 during a particular call session. In other words, even if a client sends multiple requests for web pages from web server 118 during a given call session, each request may be referred to herein as the “first request.” Call information associated with the call session may be retrieved at block 304. Caller information using the call information may be retrieved at block 306. A dynamic web page may be generated using the caller information at block 308. The web page may be sent in response to the first request at block 310. An example of a dynamic web page may be a script page for an IVR system.

In one embodiment, web server 118 may receive the first request from media server 108 or agent workstation 110, for example. Web server 118 may use the call information interface module to retrieve call information associated with the call session from CTI server 112. The call information may comprise, for example, a number dialed by the caller. CTI server 112 may receive the dialed number from a Dialed Number Information Service (DNIS) system, for example. Web server 118 may use the caller information interface module to retrieve caller information from enterprise server 114. Web server 118 may also use the caller information interface to retrieve some caller information from disk storage 218. This maybe particularly desirable for those implementations having the need for greater processing throughput. For example, web server 118 may use the caller information to retrieve an IVR script or web page template for media server 108. Web server 118 may use the web page generator to generate a web page using the call information and/or caller information. Web server 118 may send the finished web page to the requesting client, such as media server 108 or agent workstation 110, for example.

In one embodiment, web server 118 may retrieve the call information using a first identifier from the first request. The first request may comprise, for example, a HTTP “get” request using a URL implicitly having the first identifier. An example of a first identifier may comprise a telephone line used for the call session.

In one embodiment, web server 118 may retrieve the call information from CTI server 112, for example. Web server 118 may send a second request to CTI server 112. The term “second request” as used herein may refer to any request between web server 118 and CTI server 112 during a call session, and not necessarily the actual second request for call information. CTI server 112 may retrieve the call information from call database 120 using the first identifier. CTI server 112 may send the call information to web server 118 in response to the second request. An example of the call information may comprise a dialed number for the call session.

In one embodiment, web server 118 may retrieve the caller information using the first identifier from the first request. For example, web server 118 may retrieve the first identifier from the first request. Web server 118 may send a second request to call database 120 of CTI server 112 with the first identifier. CTI server 112 may retrieve a second identifier, and send it to web server 118. The second identifier may represent, for example, information provided by the caller during the call session and previously stored in the call database. An example of a second identifier may be an account number and PIN. Web server 118 may receive the second identifier in response to the second request. Web server 118 may send a third request to caller database 122 of enterprise server 114 with the second identifier, or use the second identifier to retrieve the caller information from disk storage 218. The term “third request” as used herein may refer to any request between web server 118 and a caller database, and not necessarily the actual third request for caller information. If retrieving the caller information from caller database 122, enterprise server 114 may retrieve the caller information using the second identifier. Enterprise server 114 may send the caller information to web server 118. Web server 118 may receive the caller information in response to the third request.

In one embodiment, the client may send the second identifier with the first request. In this case, web server 118 may retrieve the second identifier directly from the first request rather than CTI server 112. Web server 118 may retrieve the caller information from a caller database stored in disk storage 218. The caller information may comprise, for example, a bank account statement for the caller. Alternatively, web server 118 may send a third request to enterprise server 114 to retrieve the caller information from caller database 122 using the second identifier. Enterprise server 114 may send the caller information to web server 118 in response to the third request.

In one embodiment, media server 108 may receive a telephone call via telephony network 104 to initiate the call session. Media server 108 may register the call with call database 120 for CTI server 112. Media server 108 may receive a request from a caller for the caller information. The request may be implicit during initiation of the call session. An example may be general purpose welcome message from the IVR system, or a custom designed welcome message based on a customer service level assigned to the caller. The request may also be explicit from the user. An example may be a Dual Tone Multi-Frequency (DTMF) digit pressed by the caller in response to a series of menu items presented to the caller. Media server 108 may generate and send the first request for the caller information to web server 118. Web server 118 may generate and send a web page to media server 108. Media server 108 may receive the web page generated by web server 118 in response to the first request. Media server 108 may reproduce the web page to the caller in audible form, e.g., reciting a dialog encoded into a script.

In one embodiment, media server 108 may send the first request for the caller information with the first identifier, the second identifier, or both, depending upon at which point media server 108 is during the call session. For example, to request an initial script page from web server 118, media server 108 may send the first identifier with the first request. Web server 118 may retrieve the call information using the first identifier, and then the caller information using the call information. If media server 108 needs to request an additional script page, perhaps in response to another request by the caller, it may also accomplish this by sending the first identifier in the first request. Prior to the request, media server 108 may register the second identifier with CTI server 112. Web server 118 may consult with CTI server 112 to retrieve the second identifier using the first identifier, and use the second identifier to retrieve the caller information from its own database or caller database 122 of enterprise server 114. To expedite the processing, however, media server 108 may send both the first and second identifiers in the first request. In this case, web server 118 may not necessarily need to consult with CTI server 112, and may proceed to use the second identifier to retrieve the caller information. This may reduce the overall processing time to generate the appropriate web page by the round-trip delay and processing time associated with consulting CTI server 112. In yet another example, media server 108 may send only the second identifier in the first request. In this case, web server 118 may need to confirm that the second identifier is for use with the call session associated with the first identifier prior to retrieving the caller information. As demonstrated above, the permutations of processing sequences may vary considerably depending upon a particular implementation, and the embodiments are not limited in this context.

In one embodiment, the telephone call may be registered with CTI server 112. CTI server 112 may receive call information associated with the telephone from telephony network 104. CTI server 112 may store the call information in call database 120.

In one embodiment, CTI server 112 may receive the second request for call information from web server 118. CTI server 112 may retrieve the call information from call database 120 using the first identifier. CTI server 122 may send the call information to web server 118 in response to the second request.

In one embodiment, enterprise server 114 may receive the second request or third request for caller information from web server 118. It is worthy to note that the second request is not necessarily the same as the second request sent to CTI server 112. Enterprise server 14 may retrieve the caller information from caller database 122 using the second identifier. Enterprise server 114 may send the caller information to web server 118 in response to the second request.

The operation of systems 100 and 200, and the programming logic shown in FIG. 3, may be better understood by way of example. Assume a call arrives from telephony network 104 and is directed to media server 108 on a certain telephone line. Media server 108 answers the call and a call session begins. At approximately the same time, telephony network 104 delivers several call status events to CTI server 112. These events report the presentation of the call, certain information about the call such as the number that was originally dialed, the actual telephone line to which the call was delivered, and the fact that media server 108 successfully answered the call. CTI server 112 records this information in call database 120 for future use.

Having answered the call, media server 108 needs to know how to greet the caller and how to proceed with dialogue after that greeting. Having no application-specific software itself, media server 108 requests an appropriate script from web server 118. It makes this request using a URL that inherently identifies the telephone line on which the subject call arrived. It is worthy to note that the telephone line identifier may be the only information known to media server 108 about the call at this point.

Web server 118 receives the request for a script page, noting the telephone line for which the page is being requested. Using the telephone line identifier from the request, the call information interface module consults CTI server 112 using a convenient data protocol such as Web Services XML/SOAP to determine additional information about the call. That additional information may include, for example, the DNIS information originally supplied by the telephony network with the call first arrived.

Using the additional information provided by CTI server 112, web server 118 constructs an appropriate web page and returns it to media server 108. For example, the DNIS information provided by CTI server 112 may indicate that the caller is using a privileged customer service telephone number and so should be provided with an appropriate greeting and privileged dialogue options.

Media server 108 receives the initial dialogue script and begins the specified dialogue with the caller. At some point in this dialogue, the caller may provide an account number and PIN and may request the reporting of the account balance. The current dialogue script may not include that function, so media server 108 may request a new dialogue script page from web server 118. That request may explicitly include the subject account number and PIN, or the Media Server may register the account number and PIN with CTI server 112 and then report to media server 108 only the telephone line identifier pertaining to the current call. In the latter case, web server 118 may retrieve the appropriate information from CTI server 112.

When web server 118 receives the request for an account balance script page, it may first consult CTI server 112 to retrieve the most current context information for the current call. Web server 118 now knows the account number and PIN pertaining to the requested dialogue page.

Web server 118 retrieves the necessary account information from caller database 122 via enterprise server 114. The account information may be communicated using any convenient networking protocol or data base access technique.

Web server 118 uses the account information and the other call context information to construct a suitable dialogue script file that will cause media server 108 to speak the requested information. Web server 118 transmits this dialogue script page to media server 108 for execution.

Media server 108 executes the specified dialogue. In response to the account information, and within the framework of the options presented in the dialogue script, the caller may request to speak to a customer service agent. In response to the request, media server 108 may transfer the call to a customer service agent at agent workstation 110. This transfer will typically be made to an ACD queue and not to a specific agent. The call will wait in the queue until the telephony network obtains a free agent line.

When telephony network 104 selects a customer service agent and delivers the call, it also provides information about the transferred call to CTI server 112 via the signaling link. CTI server 112 records this information for future use.

When the call begins to ring at agent workstation 110, the customer service representative may have a web browser running and may have already fetched an initial ‘ready’ page to await information about the call and/or the caller. If the customer service representative wants to see information about the call and/or caller, the customer service representative may click on the corresponding link on the ‘ready’ page. This causes the web browser to request another page from web server 118. This request includes the identification of the telephone line or agent to which the call is being presented. It is worthy to note that the line or agent identifier may be the only information about the call known to the web browser at that time. It is also worthy to note that standard web ‘push’ technology could be used to automatically present the caller data screen instead of waiting for the request from agent workstation 110.

When it receives the request, the web browser may use the call information interface module to consult CTI server 112 once more to determine the call context for the request. This call context may include, for example, the account identification previously collected by media server 108.

Once it has received the call context information, web server 118 consults caller database 122 via enterprise server 114 to retrieve the necessary information about the caller. Using the template for the requested page, web server 118 uses the collected information to construct a web page containing that information and transmits it to the agent's web browser.

While certain features of the embodiments have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. A method to manage information, comprising:
receiving a first request for caller information during a call session;
retrieving call information associated with said call session;
retrieving caller information using said call information;
generating a dynamic web page using said caller information; and
sending said web page in response to said first request.

2. The method of claim 1, wherein said retrieving said call information comprises:
retrieving a first identifier from said first request;
sending a second request to a call database using said first identifier; and
receiving said call information in response to said second request.

3. The method of claim 2, wherein said first identifier identifies a telephone line used for said call session.

4. The method of claim 1, wherein said retrieving said caller information comprises:
retrieving a first identifier from said first request;
sending a second request to a call database using said first identifier;
receiving a second identifier in response to said second request;
sending a third request to a caller database using said second identifier; and
receiving said caller information in response to said third request.

5. The method of claim 4, wherein said first identifier represents a telephone line, and said second identifier represents information provided by a caller and stored in said call database.

6. The method of claim 1, wherein said retrieving said caller information comprises:
retrieving a second identifier from said first request;
sending a third request to a caller database using said second identifier; and
receiving said caller information in response to said third request.

7. The method of claim 6, wherein said second identifier comprises information provided by a caller.

8. The method of claim 6, wherein said second identifier comprises an account number and personal identification number provided by a caller.

9. The method of claim 1, wherein said dynamic web page is a script for an interactive voice response system.

10. The method of claim 1, further comprising:
receiving a telephone call to initiate said call session;
registering said call with a call database;
receiving a request from a caller for said caller information; and
sending said first request to a web server for said caller information.

11. The method of claim 10, further comprising:
receiving said web page in response to said first request; and
providing said information to said caller in audible form.

12. The method of claim 10, wherein said registering comprises:
receiving call information associated with said telephone call; and
storing said call information in a call database.

13. The method of claim 2, further comprising:
receiving said second request;
retrieving said call information from said call database using said first identifier; and
sending said call information in response to said second request.

14. The method of claim 4, further comprising:
receiving said third request;
retrieving said caller information from said caller database using said second identifier; and
sending said caller information in response to said third request.

15. The method of claim 6, further comprising:
receiving said third request;
retrieving said caller information from said caller database using said second identifier; and
sending said caller information in response to said third request.

16. An apparatus, comprising:
a communications web services interface to retrieve information during a call session; and
a web page generator to generate a web page using said information.

17. The apparatus of claim 16, wherein said communications web services interface comprises:
a call information interface to retrieve call information associated with said call session; and
a caller information interface to retrieve caller information associated with a caller for said call session.

18. The apparatus of claim 16, wherein said web page generator comprises:
a plurality of templates to generate web pages;
a selection module to select a template for said web page; and
a creation module to build said web page using said template and said information.

19. A system, comprising:
an antenna;
a communications web services interface to retrieve information during a call session over said antenna; and
a web page generator to generate a web page using said information.

20. The system of claim 19, further comprising:
a media server to reproduce said web page to a caller in an audible form;
a telephone system to create said call session between said caller and media server;
a call database to store call information for said call session;
a caller database to store caller information for said caller; and
wherein said communications web services interface retrieves said information from said call database and said caller database during said call session, and sends said information to said web page generator to generate said web page.

21. The system of claim 20, wherein said media server comprises an interactive voice response system.

22. The system of claim 20, wherein said telephone system comprises one of a private branch exchange, centrex system, automatic call distribution system, and voice over packet system.

23. An article comprising:
a storage medium;
said storage medium including stored instructions that, when executed by a processor, result in managing information by receiving a first request for information for a caller during a call session, retrieving call information associated with said call session, retrieving caller information using said call information, generating a dynamic web page using said caller information, and sending said web page in response to said first request.

24. The article of claim 23, wherein the stored instructions, when executed by a processor, further result in said retrieving said call information by retrieving a first identifier from said first request, sending a second request to a call database using said first identifier, and receiving said call information in response to said second request.

25. The article of claim 23, wherein the stored instructions, when executed by a processor, further result in said retrieving said caller information by retrieving a first identifier from said first request, sending a second request to a call database using said first identifier, receiving a second identifier in response to said second request, sending a third request to a caller database using said second identifier, and receiving said caller information in response to said third request.

26. The article of claim 23, wherein the stored instructions, when executed by a processor, further result in said retrieving said caller information by retrieving a second identifier from said first request, sending a second request to a caller database using said second identifier, and receiving said caller information in response to said second request.
